(19) United States
(12) Patent Application Publication
(10) Pub. No.: US 2015/0359000 A1
(43) Pub. Date: Dec. 10, 2015

(54) MULTI-USER SCHEDULING CHANNEL STATUS REPORTING FOR WI-FI

(71) Applicants: Qinghua LI, San Ramon, CA (US); Huaning Niu, Milpitas, CA (US); Robert Stacey, Portland, OR (US); Guoqing Li, Portland, OR (US); Hujun Yin, Saratoga, CA (US); Rongzhen Yang, Shanghai (CN)

(72) Inventors: Qinghua LI, San Ramon, CA (US); Huaning Niu, Milpitas, CA (US); Robert Stacey, Portland, OR (US); Guoqing Li, Portland, OR (US); Hujun Yin, Saratoga, CA (US); Rongzhen Yang, Shanghai (CN)

(21) Appl. No.: 14/487,767

(22) Filed: Sep. 16, 2014

Related U.S. Application Data
(60) Provisional application No. 62/009,468, filed on Jun. 9, 2014.

(51) Int. Cl. H04W 74/06; H04W 88/08

(52) U.S. Cl. CPC H04W 74/06; H04W 88/08

(57) ABSTRACT

Provided are systems and methods for polling, by a wireless network access point, a group of wireless network stations for an uplink transmission status, receiving (from one or more wireless network stations of the group of wireless network stations) an uplink transmission status report indicating that the wireless network station is ready for uplink data transmission, scheduling (in response to receiving the one or more uplink transmission status reports) one or more uplink data transmissions from the one or more wireless network stations, and receiving (from the one or more wireless network stations in accordance with the scheduling) one or more uplink data transmissions comprising uplink data.

### PRIORITY CLAIM

This application claims benefit of and priority to U.S. Provisional Patent Application No. 62/009,468 filed on Jun. 9, 2014, titled “MULTI-USER SCHEDULING CHANNEL STATUS REPORTING FOR WI-FI,” the disclosure of which is hereby incorporated by reference in its entirety.

### TECHNICAL FIELD

This application relates to wireless networks, and more particularly to scheduling and performing wireless network uplink communications.

### BACKGROUND

Wireless communication networks enable various forms of communication without the use of wires and cables. Wireless networks include, for example, cellular phone networks, wireless local area networks (WLANs), and the like. A WLAN links two or more devices using some form of a wireless distribution method (e.g., a spread-spectrum or an orthogonal frequency-division multiplexing (OFDM) radio). A WLAN typically includes an access point (AP) that connects other communication devices, or stations (STAs), to other network resources, such as the Internet. A WLAN that conforms to the Institute of Electrical and Electronics Engineers (IEEE) 802.11 standard is often referred to as a WiFi® network.

The various standards, including the IEEE 802.11 standard, are constantly evolving to keep pace with technological demands. For example, the WLAN, IEEE 802.11ax (High-Efficiency Wi-Fi (HEW)) standard includes two additional features: uplink multiuser multiple-input and multiple-output (UL MU-MIMO) and orthogonal frequency-division multiple access (OFDMA). For both of these features, an access point schedules the transmission of data to, and the reception of data from, multiple stations. Unfortunately, an access point is not always informed of the status of a station. As a result, there are instances in which an access point allocates resources to transfer/receive data from a station despite the fact that there is no data to be transferred. For example, an access point may reserve a channel for an uplink transmission from a station, despite the fact that there is no uplink data to transfer (e.g., the station's buffer is empty). Such an unused reservation can waste resources that could be allocated to other operations. Thus, there is a need for a technique that efficiently schedules uplink data transfers between wireless access points and stations.

### BRIEF DESCRIPTION OF THE DRAWINGS

FIG. 1 is a block diagram illustrating an exemplary network environment in accordance with one or more exemplary embodiments.

FIGS. 2A and 2B are high-level timing diagrams illustrating uplink burst transmissions in accordance with one or more exemplary embodiments.

FIGS. 3A and 3B are high-level timing diagrams illustrating multi-poll scheduling of uplink burst transmissions in accordance with one or more exemplary embodiments.

FIGS. 4 and 5 are flow diagrams illustrating methods for performing uplink burst transmissions in accordance with one or more embodiments.

FIG. 6 is a block diagram illustrating an exemplary communication device in accordance with one or more exemplary embodiments.

FIG. 7 is a block diagram illustrating an exemplary computer device in accordance with one or more exemplary embodiments.

### DETAILED DESCRIPTION

The present embodiments will now be described more fully hereinafter with reference to the accompanying drawings in which exemplary embodiments are shown. Embodiments may, however, be provided in many different forms and should not be construed as limited to the illustrated embodiments set forth herein. Rather, these exemplary embodiments are provided so that this disclosure will be thorough and complete, and will fully convey the scope of the disclosure to those skilled in the art.

In some embodiments, systems and methods are provided for scheduling and performing wireless network uplink burst transmissions. An uplink burst transmission (also referred to herein as an “uplink data communication,” “uplink data transmission,” or “uplink data transfer”) may include a wireless transfer of data (e.g., “uplink data”) from a wireless network station (“station” or “STA”) to a wireless network access point (“access point” or “AP”). The uplink burst transmission may be completed in accordance with a wireless local area network (WLAN) standard, such as the Institute of Electrical and Electronics Engineers (IEEE) 802.11ax (High-Efficiency Wi-Fi (HEW)) standard, and or features thereof, such as IEEE 802.11ax (HEW) uplink multiuser multiple-input and multiple-output (UL MU-MIMO) and orthogonal frequency-division multiple access (OFDMA) features. Although certain embodiments are described in the context of the access point serving stations using time division multiplexing (TDM) for the purpose of illustration, embodiments may include any suitable technique. For example, the access point may serve the selected users by using frequency division multiplexing (FDM), time division multiplexing (TDM), spatial multiplexing (SM), or combinations thereof. In the uplink, the SM is the uplink multiuser MIMO, and the FDM is the OFDMA.

In some embodiments, uplink burst transmissions are facilitated by determining the status of stations (e.g., polling stations to determine whether they have uplink data to transfer), scheduling uplink transmissions (e.g., uplink blocks) based on the statuses of the stations, and performing uplink communications in accordance with the uplink schedule (e.g., transmitting uplink data from a station to the access point during a corresponding uplink block assigned to the station).

In some embodiments, an access point polls stations to determine whether any of the stations have uplink data to transfer to the access point. Polling may include, for example, the access point broadcasting a poll message to a plurality of stations. In some embodiments, the poll message includes a group identifier that corresponds to a group of network stations to which the poll message is directed. The group may include a subset of the plurality of stations that actually receive the broadcasted poll message. The poll message may specify that responses by the stations are to be returned during one or more reporting periods (“reporting windows”). The poll message may specify the size of uplink blocks that are available to the stations for the transfer of uplink data. In some embodiments, the poll message may be piggybacked with (e.g., combined with or contained in) another transmission, such as a broadcast or multicast downlink packet. In some embodiments, the access point reserves a wireless network channel for a duration that is long enough to encompass the uplink polling process (e.g., the broadcast of the uplink poll message and the subsequent reporting window) and/or the uplink transmission process (e.g., the uplink transmissions from one or more stations and follow-up communications, such as acknowledgement (ACK) messages).

If a station that receives the poll message is a member of the group to which the poll message is directed and it is ready for uplink data transmission (e.g., it is ready for an uplink transfer and/or has uplink data to transfer to the access point), the station may return an uplink transmission status report (“report”) in the reporting window. The report may indicate that the station is ready for uplink data transmission (e.g., it is ready for an uplink transfer and/or has uplink data for transfer) via an uplink burst transmission. In some embodiments, the report includes: (a) a single bit identifier indicating that the network station is ready for uplink data transmission (e.g., it is ready for an uplink transfer and/or has uplink data to be transferred) via an uplink transmission and/or (b) a buffered data size specifying an amount of data stored in a buffer of the network station that is ready to be transferred via an uplink data transmission. In some embodiments, a report includes a clear channel assessment (CCA) channel status or bandwidth request response. In some embodiments, a report is transmitted over a unique subcarrier. In some embodiments, the poll message includes instructions to transmit the CCA channel status response over a unique subcarrier. In some embodiments, the report comprises a measurable variance in a power level on a subcarrier of an OFDM symbol that is indicative of its having uplink data to transfer. In some embodiments, a report is transmitted to the access point using Frequency Division Multiple Access (FDMA).

If a station that receives the poll message is not a member of the group to which the poll message is directed, it does not have sufficient uplink data to transfer to the access point (e.g., it does not have any data or does not have enough data to substantially fill the uplink reserved duration, such as fill at least 33% of the reserved duration), or it is otherwise blocked from communicating with the access point or transmitting an uplink burst during an available uplink block, the station may remain quiet, e.g., the station may not return a report. A station may be blocked from communicating if, for example, a device other than the access point has set an unexpired reservation that prevents the station from communicating or participating in one of the available uplink blocks. In some embodiments, a polled station may be blocked from communicating and, thus, remain quiet/wait if (1) there is some ongoing communication in the vicinity (e.g., the polled station has an unexpired NAV set by a device other than the polling access point) and/or (2) the polled station senses a significant signal power above a threshold in the medium.

In response to receiving one or more reports in the reporting window, the access point may schedule corresponding uplink burst transmissions. If, for example, only a single station sends a report (or multiple stations send a report, but only one is serviceable), the access point may schedule a single uplink block (e.g., a 2 ms (millisecond) block) for the station to transmit its uplink data to the access point on the reserved channel. A serviceable report may include a report for which a corresponding transmission can be serviced (e.g., it is received in the reporting window and at least a portion of the uplink data can be transferred) in a transmission period immediately following the reporting window in which the report is received. A report may not be serviceable if, for example, the requested uplink data transmission is too large to be scheduled within the transmission period immediately following the reporting window in which the report is received, or the entire report is not received within the reporting window. If there is not enough stations (e.g., more than three stations) providing serviceable reports, the access point may send another poll to another group of stations for collecting additional reports before scheduling the uplink transmission burst. The uplink block may be allocated during the period in which the channel is reserved by the access point. If, for example, two stations send a report that is serviceable, the access point may schedule an uplink block for each of the stations to transmit its uplink data to the access point on the reserved channel (e.g., a first 1 ms block for use by the first station to transmit its uplink data to the access point on the reserved channel, and a second 1 ms block for use by the second station to transmit its uplink data to the access point on the reserved channel). The access point may schedule the uplink block(s) (and reserve the channel for the uplink block(s)) during the period in which the channel is reserved by the access point. In some embodiments, the access point selects a certain subset of the stations and schedules their transmissions. For example, if five stations indicate that they have data to send, but the access point determines that only four of them can be served during the transmission period, the access point may select and serve four of the five reports during the corresponding transmission period. The remaining station may have to wait for (or be scheduled for) a subsequent transmission process.

The scheduling may provide for efficient allocation of resources including, for example, making use of uplink blocks that may otherwise be reserved for an uplink transmission by a station despite the fact that the station does not have uplink data to transfer to the access point. In some embodiments, if the access point reserves a network channel for a duration sufficient to cover allocation of an uplink block to each of a plurality of stations, and one or more of the stations do not need their allocated uplink block, the access point may reallocate the reserved time to other stations. For example, if the access point reserves 4 ms on a network channel for uplink transmissions, and receives reports from four stations, the access point may schedule a 1 ms uplink block for each of the four stations. If however, the access point only receives reports from three stations, the access point may schedule approximately 1.33 ms uplink blocks for each of the three stations. In an alternative, if one of the three stations has a relatively large amount of uplink data (e.g., that needs more than 1.33 ms and the other stations can complete their uplink burst transmission in 1 ms or less), the access point may schedule a 2 ms uplink block for that station and 1 ms uplink blocks for each of the other two stations.

In some embodiments, the access point may dynamically reserve a network channel based on the reports received from stations, further enabling the efficient allocation of resources. In some embodiments, an access point initially reserves a network channel for a first period sufficient to cover the uplink polling process (e.g., the broadcast of the uplink poll message and the subsequent reporting window) and later, if needed, reserves the channel for a second period sufficient to cover any corresponding uplink transmission process (e.g., the uplink transmissions from one or more stations and follow-up communications, such as acknowledgements). For example, an access point may initially reserve a network channel for a first period (e.g., 48 μs (micro seconds)—a duration sufficient to cover 24 μs needed for broadcast of the uplink poll message and a 16 μs short interframe space (SIFS) and a subsequent 8 μs reporting window for receiving reports that are 8 μs in duration). If the results of polling indicate that no uplink transmissions are to be conducted (e.g., no serviceable reports are received by the access point from the stations in the reporting window), the access point may release the channel, e.g., not extend the reservation of the channel. If, however, the results of polling indicate that uplink transmissions are to be conducted, the access point may extend the reservation of the channel for a second period sufficient to cover the corresponding uplink transmission process. If, for example, a serviceable report is received from only one station during the polling process and the access point determines that approximately 2 ms is needed to complete the corresponding uplink transfer, the access point may extend the channel reservation by approximately 2.1 ms (e.g., reserve a 2.1 ms block of time immediately following the first reservation) to provide enough time to complete the corresponding uplink transmission process, and allocate a 2 ms uplink block (during the extended reservation) for use by the station to transfer its uplink data to the access point. If, for example, a report is received from two stations during the polling process and the access point determines that approximately 1 ms is needed to complete each of the corresponding uplink transfers, the access point may extend the channel reservation by approximately 2.1 ms (e.g., reserve a 2.1 ms block of time immediately following the first reservation) to provide enough time to complete the corresponding uplink transmission process, and allocating a first 1 ms uplink block (during the extended reservation) for use by the first station to transfer its uplink data to the access point and a second 1 ms uplink block (during the extended reservation) for use by the second station to transfer its uplink data to the access point. Thus, the access point may dynamically implement/adjust its channel reservation to cover only the time needed for the corresponding uplink transfers, releasing the channel for use by other processes. For example, if the access point initially overbooked the channel and the uplink data cannot fully fill the reserved duration, the access point may free the unused duration (e.g., after sending the ACK or BACK to the station) by sending a contention-free-end frame.

In some embodiments, the uplink data received in an uplink block is accompanied by and/or includes a supplemental report (e.g., appended to the end of the data, prefixed to the data or otherwise embedded therein) indicating that the station has additional uplink data to be transferred via an uplink data transmission. In response to receiving such a supplemental report, the access point may schedule, based at least in part on the supplemental report, one or more additional uplink data transmissions from the station. For example, the access point may schedule, in a subsequent transmission period, an additional uplink block reserved for transferring the additional uplink data from the station.

In some embodiments, the uplink transmission process includes the access point generating and sending an uplink map. The uplink map may specify the schedule for the uplink transmissions and related transmissions. The access point may broadcast, unicast, or multicast the uplink map to the plurality of stations after the reporting window, but before the start of the first uplink block of the transmission period. The transmission of the uplink map may be performed, e.g., via a downlink multiuser multiple-input multiple-output (MU-MIMO) transmission for enhancing reliability. In some embodiments, the uplink map specifies the assignment of uplink blocks including, for example, the start/end times for each uplink block and an identification of which station is assigned to transfer its uplink data to the access point during the respective uplink block. For example, in the case where only a single station sends a serviceable report and the access point schedules a single uplink block (e.g., a 4 ms block of time) for the station to transmit its uplink data to the access point on the reserved channel, the uplink map may specify that the station is assigned to an uplink block having a start time 16 μs after the termination of the uplink map frame and a duration of 4096 μs on channel 1. The access point may schedule transmission of the uplink map, the uplink block(s), and any other related transmissions, such as acknowledgement (ACK) messages and/or block acknowledgement (BA) messages, during what is referred to as the transmission period.

In some embodiments, multiple reporting windows are employed to provide stations with flexibility in responding to the polling messages. For example, an access point may specify a first reporting window that follows the transmission of the polling message, a first transmission period that occurs after the first reporting window, a second reporting window that occurs after the first transmission period, and a second transmission period that occurs after the second reporting window. In such an embodiment, a station that is not ready or is otherwise unable to send a report during the first reporting window may instead send a report during the second reporting window. The access point may schedule transmission of a first uplink map, indicating a schedule for some or all of the uplink block(s) resulting from the serviceable reports received during the first reporting window, and other related transmissions, such as acknowledgements (ACKs), during what is referred to as a first transmission period. The access point may schedule transmission of a second uplink map, indicating a schedule of some or all of the uplink block(s) resulting from the serviceable reports received during the first and second reporting windows, and other related transmissions, such as acknowledgements (ACKs), during what is referred to as a second transmission period.

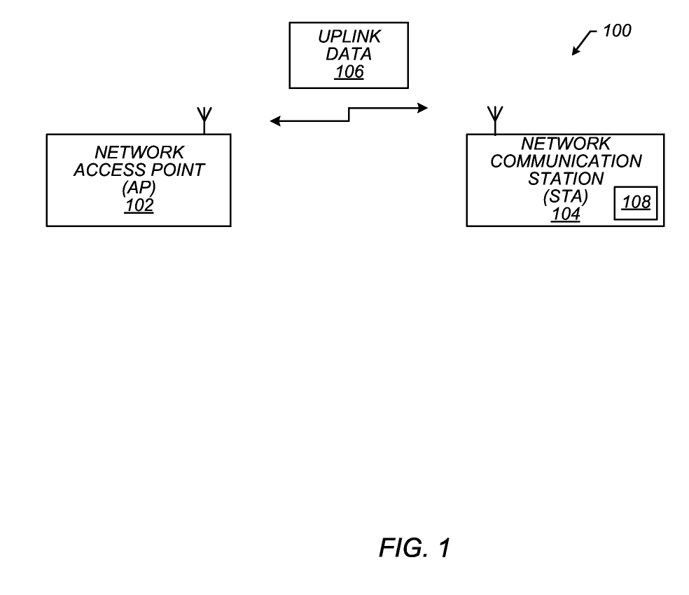

FIG. 1 is a block diagram illustrating an exemplary network environment (wireless network) 100 in accordance with one or more exemplary embodiments. Wireless network 100 includes one or more wireless network access points (“access points” or “APs”) 102 and a plurality of wireless network communication stations (“stations” or “STAs”) 104. A STA 104 may transmit data (“uplink data”) 106 to an AP 102 via an uplink data transfer operation, as discussed herein. For example, the STA 104 may store uplink data 106 in a buffer 108 and may wirelessly transfer the buffered data to the AP 102 via an uplink burst transmission in accordance with one or more of the techniques described herein.

The wireless network 100 may include a computer network that uses wireless data connections for connecting network nodes. In some embodiments, the wireless network 100 is a wireless local area network (WLAN). Wireless network 100 may include a “Wi-Fi” network, conforming to the IEEE 802.11 standard including, for example, the WLAN, IEEE 802.11ax (HEW) standard. APs 102 and STAs 104 may communicate in accordance with the IEEE 802.11 standard including, for example, the WLAN, IEEE 802.11ax (HEW) standard. Wireless network 100 may link APs 102 and STAs 104 via spread-spectrum or orthogonal frequency-division multiplexing (OFDM) radio distribution. Wireless network 100 may be suitable for FTM Burst Management.

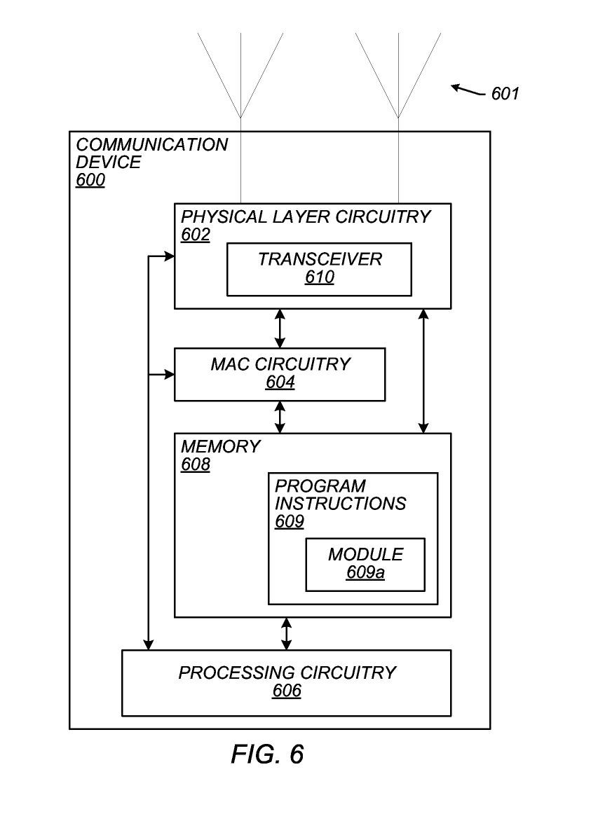

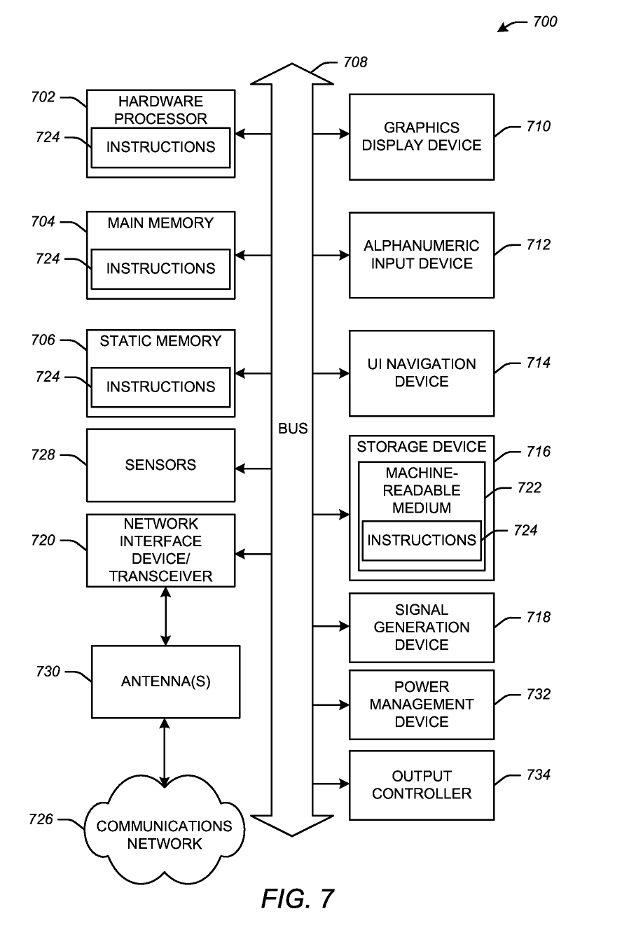

A wireless access point (AP) 102 may include a device that allows wireless devices (e.g., STAs 104) to connect to a wired network using Wi-Fi, or similar wireless communication techniques. An AP 102 may connect to a network router (e.g., via a wired network) as a standalone device, or may be an integral component of a router itself. An AP 102 may connect other devices, or STAs 104, to other network resources, such as the Internet. An AP 102 may be mobile or stationary. An AP 102 may be referred to as an access node, a base station, or some other similar terminology. An AP 102 may include a computer device, such as that depicted and described in more detail below with regard to FIG. 6 and/or FIG. 7.

A wireless network communication station (STA) 104 may include a wireless communication device such as a cellular telephone, a smartphone, a tablet, a netbook, a wireless terminal, a laptop computer, a femtocell, a High Data Rate (HDR) subscriber station, an access point, an access terminal, or other personal communication system (PCS) device. A STA 104 may be mobile or stationary. A STA 104 may be referred to as a mobile station, a device node, a user device/user equipment (UD/UE), a wireless communication device, and/or some other similar terminology. A STA 104 may include a computer device, such as that depicted and described in more detail below with regard to FIG. 6 and/or FIG. 7.

In accordance with some IEEE 802.11ax (High-Efficiency Wi-Fi (HEW)) embodiments, an AP 102 may operate as a master station which is arranged to contend for a wireless medium (e.g., during a contention period) to receive exclusive control of the medium for an HEW control period (i.e., a transmission opportunity (TXOP)). Acting as a master station, the AP 102 may transmit an HEW master-sync transmission at the beginning of the HEW control period. Although some Wi-Fi communications include devices communicating in accordance with a contention-based communication technique, during the HEW control period, STAs 104 (referred to as HEW STAs 104) may communicate with the master station AP 102 in accordance with a non-contention-based multiple access technique. During the HEW control period, the master station AP 102 may communicate with HEW STAs 104 using one or more HEW frames. During the HEW control period, other (e.g., legacy) STAs 104 refrain from communicating. In some embodiments, the master-sync transmission may be referred to as an HEW control and schedule transmission. The master station AP 102 may also communicate with legacy STAs 104 in accordance with legacy IEEE 802.11 communication techniques. In some embodiments, the master station AP 102 may also be configurable to communicate with HEW STAs 104 outside the HEW control period in accordance with legacy IEEE 802.11 communication techniques.

In some embodiments, the multiple-access technique used during the HEW control period may be a scheduled orthogonal frequency division multiple access (OFDMA) technique. In some embodiments, the multiple access technique may be a time-division multiple access (TDMA) technique or a frequency division multiple access (FDMA) technique. In some embodiments, the multiple access technique may be a space-division multiple access (SDMA) technique (sometimes referred to as “downlink MU-MIMO”). In some embodiments, the multiple access technique may be an uplink multiuser multiple-input multiple-output (MU-MIMO) technique. For example, multiple stations can send uplink data on the same frequency-time resource. The access point may use multiple receiver antennas to separate the superimposed signals from the stations.

In some embodiments, the links of an HEW frame may be configurable to have the same bandwidth. The bandwidth may be one of 20 MHz, 40 MHz, or 80 MHz contiguous bandwidths or an 80+80 MHz (160 MHz) non-contiguous bandwidth. In some embodiments, a 320 MHz contiguous bandwidth may be used. In some embodiments, bandwidths of 5 MHz and/or 10 MHz may also be used. In these embodiments, each link of an HEW frame may be configured for transmitting a number of spatial streams.

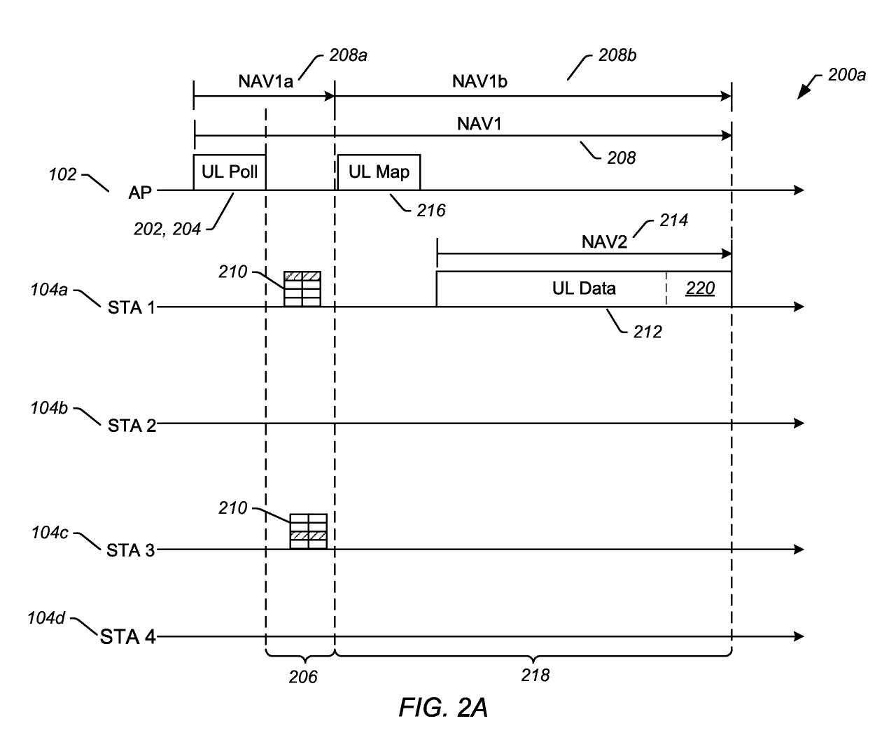

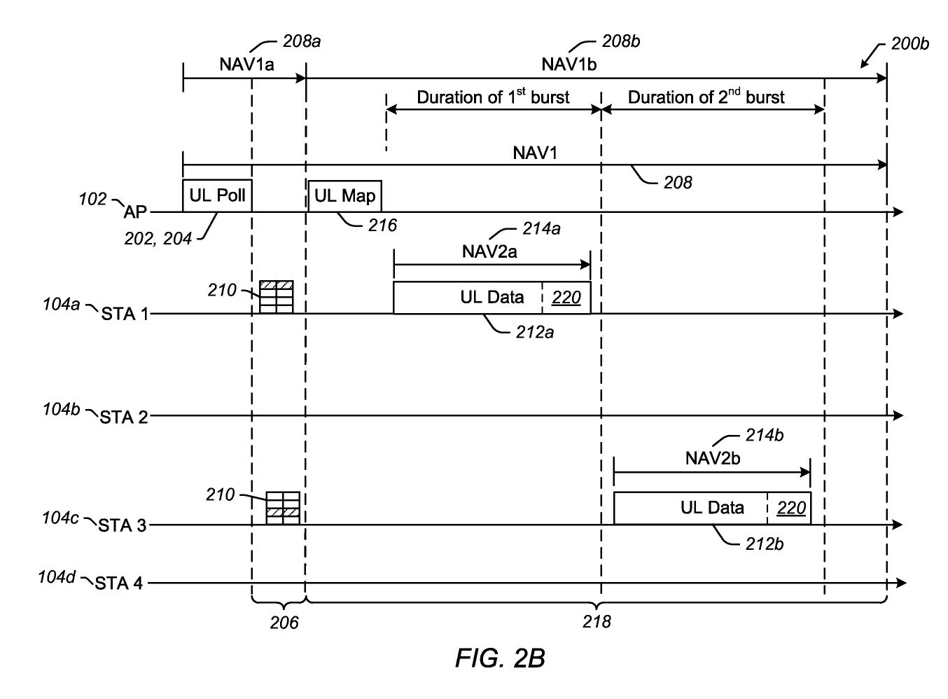

FIGS. 2A and 2B are high-level timing diagrams illustrating uplink burst transmissions (also referred to herein as “uplink transmissions” and “uplink data transmissions”) in accordance with one or more exemplary embodiments. FIG. 2A is a high-level timing diagram 200a illustrating a single uplink burst transmission in accordance with one or more exemplary embodiments. FIG. 2B is a high-level timing diagram 200b illustrating an uplink multiple burst (multi-burst) transmission in accordance with one or more exemplary embodiments.

Referring to an embodiment of FIG. 2A, the AP 102 may poll STAs 104 to determine whether they have uplink data 106 to transfer. Polling may include, for example, the AP 102 broadcasting an uplink poll message (UL Poll) 202 to a plurality of STAs, including STA1 104a, STA2 104b, STA3 104c, and STA4 104d. In some embodiments, the poll message 202 includes a group identifier 204 that corresponds to a group of the STAs 104 to which the poll message 202 is directed. The group identifier 204 may include, for example, the ID “1234” that corresponds to a group including STA1 104a, STA2 104b, STA3 104c (but not including STA4 104d), e.g., a group that is a subset of the plurality of STAs 104 that are asked to receive the broadcasted poll message 202. Some addressed STAs 104 may not actually receive the poll message 202 because it may be jammed by an interference signal, such as that from a neighboring cell transmission. The poll message 202 may specify that responses by the STAs 104 are to be returned during a reporting time period (“reporting window”) 206.

In some embodiments, the AP 102 reserves a wireless network channel for a duration that is long enough to encompass the uplink polling process (e.g., the broadcast of the uplink poll message 202 and the subsequent reporting window 206) and/or the uplink transmission process (e.g., the uplink transmissions from one or more STAs 104 during uplink blocks 212 and follow-up communications, such as acknowledgement messages (ACKs)). In one embodiment, the AP 102 has reserved the wireless network channel for the duration indicated by the network allocation vector (NAV1) 208.

If a STA 104 that receives the poll message 202 is a member of the group to which the poll message 202 is directed (e.g., the group corresponding to group ID “1234”), and it has sufficient uplink data 106 (e.g., some data or an amount of data above a threshold) to transfer to the AP 102 and STA 104 is not blocked from transmission (e.g., by a device other than the AP 102), the STA 104 may return an uplink transmission status report (“report”) 210 within the reporting window 206. For example, in the illustrated embodiment, STA1 104a is a member of the group “1234” to which the poll message 202 is directed and is ready for uplink data transmission (e.g., it is ready for an uplink transfer and/or it has uplink data 106 to transfer) to the AP 102 and, thus, the STA1 104a returns a report 210 in the reporting window 206. The report 210 may indicate that the STA 104 is ready for uplink data transmission (e.g., it is ready for an uplink transfer and/or has uplink data 106 for transfer) via an uplink transmission. The report may include (a) a single bit identifier indicating that the STA1 104a is ready for uplink data transmission (e.g., it is ready for an uplink transfer and/or has uplink data 106 to be transferred) via an uplink transmission and/or (b) a buffered data size (e.g., 1 KB (kilobyte)) specifying an amount of data stored in the buffer 108 of the STA1 104a (e.g., that is ready to be transferred via an uplink data transmission) and/or (c) the STA1 104a is not blocked from transmission, e.g., the channel is free for the uplink transmission likely to be scheduled.

If a STA 104 that receives the poll message 202 is not a member of the group to which the poll message 202 is directed, it does not have uplink data 106 to transfer to the AP 102, or it is otherwise blocked from communicating with the AP 102, the STA 104 may remain quiet, e.g., the STA 104 may not return a report 210. For example, in the illustrated embodiment, the STA 104b remains quiet because it is blocked by another STA 104 from communicating with the AP 102, and the STA 104d remains quiet because it is not a member of the group “1234” to which the poll message 202 is directed.

In response to receiving one or more reports in the reporting window 206, the AP 102 may schedule corresponding uplink transmissions. If, for example, only a single STA 104 sends a report (or multiple STAs 104 send reports, but only one is serviceable), the AP 102 may schedule a single uplink block 212. In the illustrated embodiment, STA1 104a and STA3 104c both provide reports 210, but the AP 102 determines that the report 210 by STA3 104c is not serviceable (e.g., the AP 102 determines that STA3 104c cannot transmit uplink data 106 during the reservation of the channel indicated by NAV1 208). As a result, the AP 102 schedules an uplink block 212 (e.g., a 2 ms uplink block) for STA1 104a to transmit its uplink data 106 to the AP 102 on the reserved channel. The AP 102 does not schedule an uplink block 212 for STA3 104c to transmit its uplink data 106 to the AP 102 on the reserved channel during the transmission period 218. The AP 102 may schedule the uplink block 212 (and reserve the channel for the uplink block 212) for STA1 104a during the period in which the channel is reserved by the AP 102, as indicated by NAV2 214.

In some embodiments, if multiple STAs 104 send reports 210 that are serviceable, the AP 102 may schedule an uplink block 212 for each of the STAs 104 to transmit their uplink data 106 to the AP 102 on the reserved channel. Although the reports are each labeled 210 for the purpose of illustration, it will be appreciated that each of the reports 210 may be different and/or may be generated by the corresponding STA 104 of the respective illustration. Referring to an embodiment of FIG. 2B, if the reports 210 sent by STA1 104a and STA3 104c are both serviceable, the AP 102 may schedule two uplink blocks 212 (e.g., a first 1 ms block 212a for use by STA1 104a to transmit its uplink data 106 to the AP 102 on the reserved channel, and a second 1 ms block 212b for use by STA3 104c to transmit its uplink data 106 to the AP 102 on the reserved channel). The AP 102 may schedule the uplink blocks 212a and 212b (and reserve the channel for the uplink blocks 212a and 212b) during the period in which the channel is reserved. The AP 102 may set NAV1b 208b for its reception of the two uplink data transmissions. STA1 104a and STA 3 104c may, then, set NAV2a 214a and NAV2b 214b, respectively in their uplink data frames. The NAVs 214a and 214b set by the STAs 104a and 104c let the other devices nearby know that they will occupy the channel for NAV2a 214a and NAV2b 214b durations.

The scheduling may provide for efficient allocation of resources including, for example, making use of the uplink blocks 212 that may otherwise be reserved for an uplink transmission by a STA 104 despite the fact that the STA 104 does not have uplink data 106 to transfer to the AP 102. In some embodiments, if the AP 102 reserves a network channel for a duration sufficient to cover allocation of an uplink block 212 to each of the plurality of STAs 104, and one or more of the STAs 104 do not need their allocated uplink blocks 212, the AP 102 may reallocate the reserved time to other STAs 104. For example, if the AP 102 reserves 4 ms on a network channel for uplink data transmissions, and receives reports 210 from four STAs 104, the AP 102 may schedule a 1 ms uplink block 212 for each of the four STAs 104. If however, the AP 102 only receives reports 210 from three STAs 104, the AP 102 may reserve approximately a 1.33 ms (e.g., 4 ms/3) uplink block 212 for each of the three STAs 104. If one of the three STAs 104 has a relatively large amount of uplink data 106 (e.g., that needs more than 1.33 ms and the other STAs 104 can complete their uplink burst transmission in 1 ms or less), the AP 102 may schedule a 2 ms uplink block 212 for that STA 104 and 1 ms uplink blocks 212 for each of the other two STAs 104. The AP 102 may schedule sending of the uplink map 216, the uplink block(s) 212, and any other related transmissions, such as acknowledgements, during a transmission period 218.

In some embodiments, the AP 102 may dynamically reserve a network channel based on the reports 210 received from the STAs 104, further enabling the efficient allocation of resources. In some embodiments, the AP 102 initially reserves a network channel for a first period sufficient to cover the uplink polling process (e.g., the broadcast of the uplink poll message 202 and the subsequent reporting window 206) and later, if needed, reserves the channel for a second period sufficient to cover any corresponding uplink transmission process (e.g., the uplink transmissions from one or more STAs 104 and follow-up communications, such as acknowledgements). For example, referring again to an embodiment of FIG. 2A, the AP 102 may initially reserve the network channel for a first period sufficient to cover the polling processes) as indicated by NAV1a 208a (e.g., for 48 μs—a duration sufficient to cover 24 μs needed for broadcast of the uplink poll message 202, a spacing of 16 μs for switching between the transmission mode and the receive mode, and a subsequent 8 μs reporting window 206 for receiving reports that are 8 μs in duration). If the AP 102 determines that no uplink transmissions are to be conducted (based at least in part on the results of the polling) (e.g., no serviceable reports 210 are received by the AP 102 from the STAs 104 in the reporting window 206), the AP 102 may release the channel, e.g., not extend the reservation of the channel. If, however, the AP 102 determines that uplink transmissions are to be conducted (e.g., based at least in part on the results of the polling), the AP 102 may extend the reservation of the channel for a second period sufficient to cover the corresponding uplink transmission process, as indicated by NAV1b 208b. If, for example, a serviceable report 210 is received from only STA1 104a during the polling process and the AP 102 determines that approximately 2 ms is needed to complete the corresponding uplink transfer, the AP 102 may extend the channel reservation by approximately 2.1 ms (e.g., reserve a 2.1 ms uplink block immediately following the first reservation) to provide enough time to complete the corresponding uplink transmission process, and allocate a 2 ms uplink block 212 (during the extended reservation) for use by the STA 104 to transfer its uplink data 106 to the AP 102. Similar techniques may be employed for multi-burst uplink transmissions. For example, referring again to an embodiment of FIG. 2B, if a serviceable report 210 is received from each of STA1 104a and STA3 104c during the polling process and the AP 102 determines that approximately 1 ms is needed to complete each of the corresponding uplink burst transfers, the AP 102 may extend the channel reservation by approximately 2.1 ms (e.g., reserve a 2.1 ms block of time immediately following the first reservation) to provide enough time to complete the corresponding uplink transmission process, and allocate a first 1 ms uplink block 212a (during the extended reservation) for use by STA1 104a to transfer its uplink data 106 to the AP 102 and a second 1 ms uplink block 212b (during the extended reservation) for use by STA3 104c to transfer its uplink data 106 to the AP 102. The extension of the channel reservation may be provided in the uplink map 216. The uplink map 216 may broadcast the channel reservation duration, e.g., setting the NAV of other devices. Thus, the AP 102 may dynamically adjust its channel reservation to cover only the time needed for the corresponding uplink transfers, releasing the channel for use by other processes during the times when it is not needed. The scheduled uplink stations STA1 104a and STA3 104c may set their respective NAVs, e.g., NAV2a 214a and NAV2b 214b, to let other devices know about their transmission durations. If the ACKs from the AP 102 are sent at the end of NAV1b, NAV2a and NAV2b may point to the end of NAV1b such that the channel is reserved for the ACKs. Although the illustrated embodiment depicts the channel reservation ending immediately following the last uplink block 212, embodiments may include adjustments to the duration of the channel reservation to account for various transmissions. For example, NAV1 208 and/or NAV1b 208b may be extended (to the right) to provide enough time for the AP 102 to transmit an acknowledgement (ACK) message following the last uplink block 212 in a given transmission period 218.

In some embodiments, the uplink data 106 received in an uplink block 212 is accompanied by and/or includes a supplemental request 220 indicating that the station has additional uplink data 106 to be transferred via an uplink data transmission. In response to receiving such a supplemental request 220, the AP 102 may schedule, based at least in part on the supplemental request 220, one or more additional uplink data transmissions from the STA 104. For example, referring to an embodiment of FIG. 2A, the AP 102 may schedule, in a subsequent transmission period 218, an additional uplink block 212, for transferring the additional uplink data 106 from the STA1 104a.

In some embodiments, the uplink transmission process includes the AP 102 generating and sending an uplink map 216. The uplink map 216 may specify or otherwise indicate the schedule for the uplink burst transmissions and related transmissions. The AP 102 may broadcast the uplink map 216 to the plurality of STAs 104 after the end of the reporting window 206, but before the start of the uplink block(s) 212. In some embodiments, the uplink map 216 specifies the assignment of the uplink blocks 212 including, for example, the start/end times (or duration) for each uplink block 212 and an identification of which STA 104 is assigned to transfer its uplink data 106 to the AP 102 during the respective uplink block 212. For example, referring to an embodiment of FIG. 2A, if only STA1 104a sends a serviceable report and the AP 102 schedules a single uplink block 212 (e.g., a 2 ms uplink block) for STA1 104a to transmit its uplink data 106 to the AP 102 on the reserved channel, the uplink map 216 may specify that STA1 104a is assigned to an uplink block 212 having a start time of 16 μs after the termination of the uplink map 216 and a duration of 2 ms. The start time may be with respect to the termination of the uplink map 216. The duration may be in the unit of OFDM or the OFDMA symbol duration, e.g., 4 μs or 16 μs.

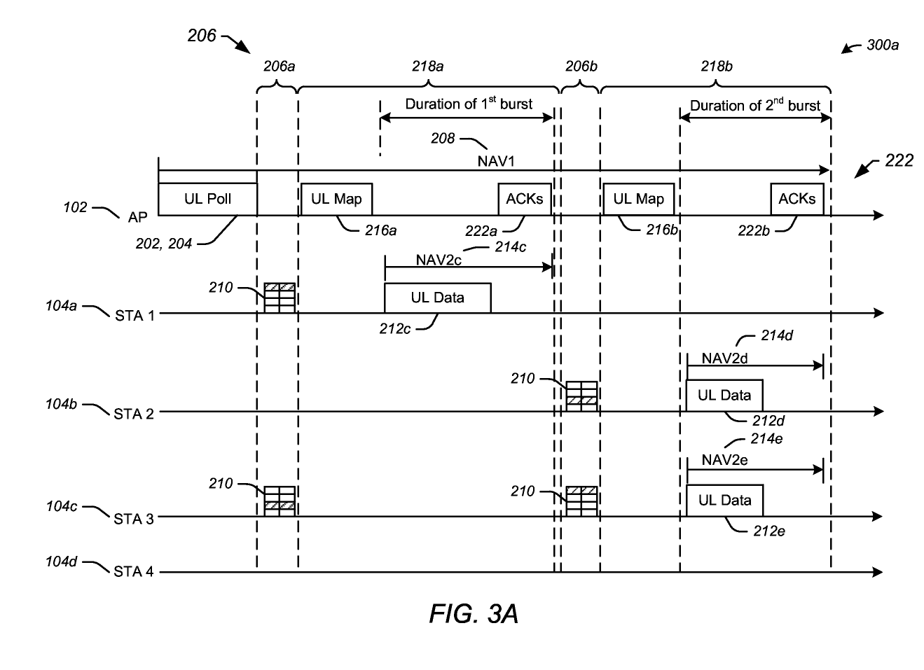

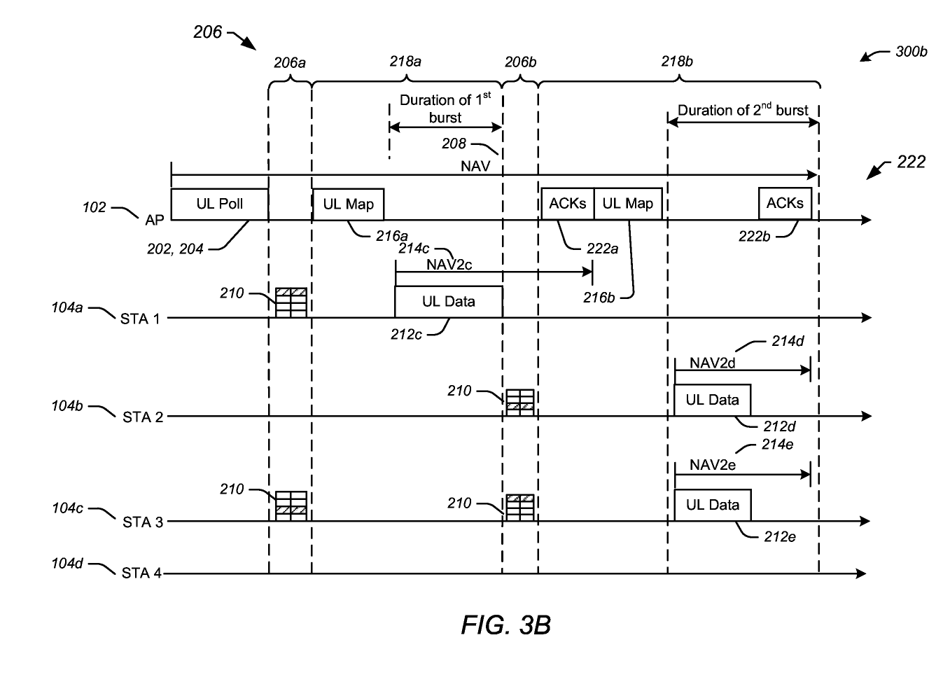

FIGS. 3A and 3B are high-level timing diagrams 300a and 300b, respectively, illustrating multi-poll scheduling of uplink burst transmissions in accordance with one or more exemplary embodiments. AP 102 may provide multiple reporting windows 206 which can provide STAs 104 with flexibility in responding to the polling messages 202. Referring to an embodiment of FIGS. 3A and 3B, for example, the polling message 202 may specify a first reporting window 206a that follows the transmission of the polling message 202, a first transmission period 218a that occurs after the first reporting window 206a, a second reporting window 206b that occurs after the first transmission period 218a, and a second transmission period 218b that occurs after the second reporting window 206b. In such an embodiment, a STA 104 that is not ready or is otherwise unable to send a report 210 during the first reporting window 206a may, instead, send a report 210 during the second reporting window 206b.

The AP 102 may schedule transmission of a first uplink map 216a, for some or all of the uplink block(s) 212 resulting from the serviceable reports 210 received during the first reporting window 206a, and other related transmissions, such as acknowledgements (ACKs) 222a, during the first transmission period 218a. The AP 102 may schedule transmission of the second uplink map 216b, for some or all of the uplink block(s) 212 resulting from the serviceable reports 210 received during the first and/or second reporting windows 206a and/or 206b, and other related transmissions, such as acknowledgements (ACKs) 222b, during the second transmission period 218b. For example, in the illustrated embodiment, reports 210 are received from STA1 104a and STA3 104c during the first reporting window 206a. AP 102 determines that the report 210 from STA1 104a is serviceable during the first transmission period 218a and, thus, schedules a corresponding uplink block 212c for transmission during the first transmission period 218a (e.g., uplink map 216a provides for scheduling uplink block 212c during the first transmission period 218a). AP 102 determines that the report 210 from STA3 104c is not serviceable during the first transmission period 218a and, thus, does not schedule a corresponding uplink block 212 for transmission during the first transmission period 218a (e.g., uplink map 216a does not provide for scheduling an uplink block 212 corresponding to the report 210 from STA3 104c during the first transmission period 218a). Reports 210 are received from STA2 104b and STA3 104c during the second reporting window 206b. Since the AP 102 already received the report 210 from STA3 104c in the first polling, the report 210 of STA3 104c for the second polling may indicate that STA3 104c is ready for transmission (e.g., not blocked from transmission by another device at the moment). The AP 102 may determine that the reports 210 from STA2 104b and STA3 104c received during the second reporting window 206b are serviceable during the second transmission period 218b and, thus, corresponding blocks 212d and 212e are scheduled for transmission during the second transmission period 218b (e.g., uplink map 216b provides for scheduling uplink blocks 212d and 212e during the second transmission period 218b). Since the uplink data transmissions 212d and 212e occur simultaneously, their transmission modes may be OFDMA or uplink MU-MIMO. The blocks are accompanied by corresponding NAV2c 214c, NAV2d 214d and NAV2e 214e.

In some embodiments, acknowledgements (ACKs) for the first set of uplink transmissions (e.g., for the uplink blocks 212 during the first transmission period 218a) are scheduled to occur before the second reporting window 206b. For example, as depicted in FIG. 3A, transmission of ACK 222a is scheduled to be completed before the start of the second reporting window 206b. In some embodiments, acknowledgements 222 for the first set of uplink transmissions (e.g., for the uplink blocks 212 during the first transmission period 218a) are scheduled to occur after the second reporting window 206b. For example, as depicted in FIG. 3B, transmission of ACK 222a is scheduled to begin after the end of the second reporting window 206b. AP 102 may implicitly schedule a reporting time (e.g., the second reporting window 206b) to start immediately after the end of the uplink transmission (e.g., immediately after the end of uplink block 212c), with the ACK 222a scheduled to begin after the end of the second reporting window 206b. Such an embodiment may alleviate the need for the AP 102 to swap from a reception mode to a transmission mode, and may remove at least two transmit/receive turnarounds for the AP 102. This may save, for example, 32 μs of overhead.

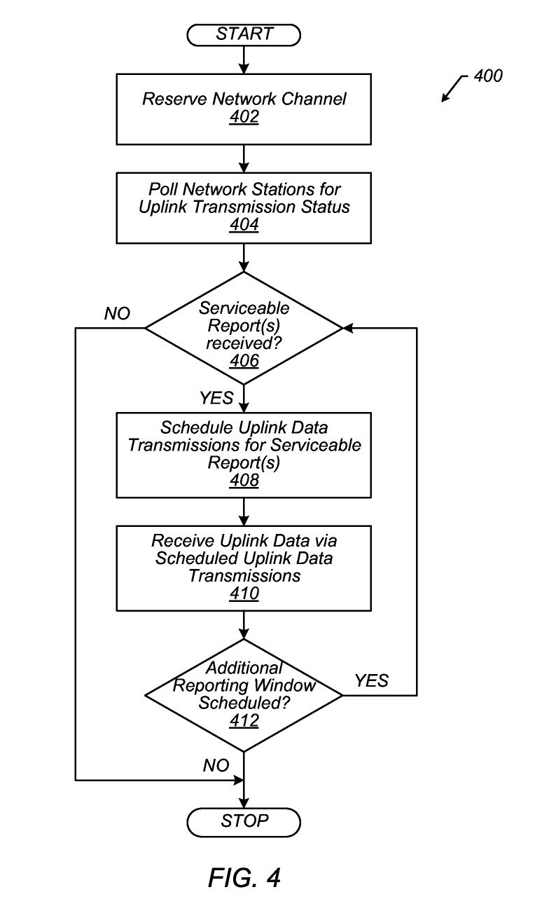

FIG. 4 is a flow diagram illustrating a method 400 for performing uplink burst transmissions in accordance with one or more embodiments of the present technique. Method 400 may generally include reserving a network channel (block 402), polling network stations for uplink transmission status (block 404), determining whether serviceable uplink transmission status report(s) have been received (block 406), scheduling uplink data (burst) transmissions for serviceable report(s) (block 408), receiving uplink data via scheduled uplink data transmissions (block 410), and if there is an additional reporting window(s) scheduled, repeating the determination of whether serviceable reports are received in the window, scheduling uplink data transmissions, and receiving uplink data. Method 400 may be employed by the AP 102.

In some embodiments, reserving a network channel (block 402) includes the AP 102 reserving a wireless network channel for a given duration. In an embodiment that includes a single channel reservation, such as that described with regard to FIG. 2A, reserving a network channel may include the AP 102 reserving a wireless network channel for a duration that is long enough to encompass the uplink polling process (e.g., the broadcast of the uplink poll message 202 and the corresponding reporting window 206) and/or the uplink transmission process (e.g., the uplink transmissions from one or more STAs 104 and follow-up communications, such as acknowledgements), e.g., as indicated by NAV1 208. In an embodiment that includes a dynamic channel reservation, such as that described with regard to FIG. 4, reserving a network channel may include the AP 102 initially reserving a network channel for a first period sufficient to cover the uplink polling process (e.g., the broadcast of the uplink poll message 202 and the corresponding reporting window 206), e.g., as indicated by NAV1a 208a. Later, if needed, the AP 102 may reserve the channel for a second period sufficient to cover any corresponding uplink transmission process (e.g., the uplink burst transmissions from one or more STAs 104 and follow-up communications, such as acknowledgements), e.g., as indicated by NAV1b 208b. Some or all of the communications/transmissions of the method 400 may be completed using the reserved channel.

In some embodiments, polling network stations for uplink transmission status reports (block 404) includes the AP 102 broadcasting a poll message 202 to a plurality of STAs 104. For example, polling network stations for uplink transmission status reports may include the AP 102 broadcasting (e.g., via the reserved channel) an uplink poll message (UL Poll) 202 to a plurality of STAs 104, including STA1 104a, STA2 104b, STA3 104c, and STA4 104d.

In some embodiments, determining whether serviceable uplink transmission status report(s) have been received (block 406) includes the AP 102 determining whether any reports 210 have been received that can be serviced (e.g., are there any reports that were received in the reporting window 206 and for which a corresponding transmission can be handled/scheduled in a transmission period 218 immediately following the reporting window 206 in which the report 210 was received). For example, referring to an embodiment of FIG. 2A, determining that a serviceable uplink transmission status report has been received may include the AP 102 determining that the report 210 received from STA1 104a is serviceable, and that the report 210 received from STA3 104c is not serviceable. In some embodiments, if it is determined that serviceable report(s) 210 have been received, the process may advance to scheduling uplink data transmissions for the serviceable report(s) (block 408). In some embodiments, if it is determined that no serviceable report(s) 210 have been received, the process may end. In some embodiments including dynamic channel reservations, if the process ends at this point, the AP 102 may not extend the channel reservation. That is, for example, the AP 102 may not reserve the channel for the second period illustrated by NAV1b 208b of FIGS. 2A and 2B, thereby releasing the channel at the end of the first period indicated by NAV1a 208a of FIGS. 2A and 2B.

In some embodiments, scheduling uplink data transmissions for serviceable report(s) (block 408), includes the AP 102 scheduling uplink data transmissions that correspond to the serviceable reports 210. For example, referring to an embodiment of FIG. 2A, scheduling uplink data transmissions for serviceable report(s) may include the AP 102 determining a schedule that includes reserving uplink block 212 for the transmission of uplink data 106 from STA1 104a (e.g., via the reserved channel). Referring to an embodiment of FIG. 2B, scheduling uplink data transmissions for serviceable report(s) may include the AP 102 determining a schedule that includes reserving uplink block 212a for the transmission of uplink data 106 from STA1 104a (e.g., via the reserved channel) and reserving uplink block 212b for the transmission of uplink data 106 from STA3 104c (e.g., via the reserved channel).

In some embodiments, scheduling uplink data transmissions for serviceable report(s) includes the AP 102 extending the reservation of the network channel. For example, referring to an embodiment of FIGS. 2A and 2B, and embodiments involving dynamic channel reservations, scheduling uplink data transmissions for serviceable report(s) 210 may include the AP 102 determining a sufficient duration to complete the transmission processes (e.g., the uplink transmissions from one or more STAs 104 and follow-up communications, such as acknowledgements) and extending the channel reservation by the duration, e.g., as depicted by NAV1b 208b. In some embodiments, scheduling uplink data transmissions for serviceable report(s) 210 includes the AP 102 determining a schedule for the transmission of uplink data 106, including the timing/schedule for sending of the uplink map 216, the uplink block(s) 212, acknowledgements and so forth, e.g., as depicted in FIGS. 2A-3B. In some embodiments, scheduling uplink data transmissions for serviceable report(s) includes the AP 102 generating an uplink map 216 that corresponds to the determined schedule. In some embodiments, scheduling uplink data transmissions for serviceable report(s) 210 includes the AP 102 transmitting the uplink map 216 (e.g., on the reserved channel) to STAs 104, e.g., as depicted at FIG. 2A.

In some embodiments, receiving uplink data via scheduled uplink data transmissions (block 410) includes the AP 102 receiving uplink data 106 in accordance with the determined schedule outlined or otherwise indicated in the uplink map 216. The uplink data 106 may be received from a STA 104 during the uplink block 212 assigned to the STA 104. For example, referring to an embodiment of FIG. 2A, receiving uplink data 106 via scheduled uplink data transmissions may include AP 102 receiving uplink data 106 from STA1 104a (e.g., via the reserved channel) during the uplink block 212. Referring to an embodiment of FIG. 2B, receiving uplink data 106 via scheduled uplink data transmissions may include the AP 102 receiving uplink data 106 from STA1 104a (e.g., via the reserved channel) during the uplink block 212a and receiving uplink data 106 from STA3 104c during the uplink block 212b. The AP 102 may store the received uplink data 106 (e.g., in memory) and/or provide for the communication of the uplink data 106 to the intended recipient (e.g., assemble the uplink data 106 received and forward corresponding data to other devices in the network 100).

In some embodiments, the method 400 includes determining if there is an additional reporting window scheduled (block 412). Such a determination may not need to be made, for example, in single-poll applications, such as those described with regard to FIGS. 2A and 2B. In such an embodiment, the transmission process may end once the AP 102 completes the transmission processes. Such a determination, however may be employed in multi-poll applications, such as those described with regard to FIGS. 3A and 3B. For example, upon the first transmission process ending, the AP 102 may repeat similar polling and transmission processes (e.g., receiving reports 210 during the next polling window 206, determining whether serviceable uplink transmission status report(s) have been received (block 406), scheduling uplink data transmissions for serviceable report(s) (block 408), and receiving uplink data via scheduled uplink data transmissions (block 410). For example, referring to embodiments of FIGS. 3A and 3B, upon completion of the first transmission period 218a, the AP 102 may determine that there is an additional/second reporting window 206b scheduled, the AP 102 may wait to receive reports 210 during the second reporting window 206b, and upon receiving the reports, repeat determining whether serviceable uplink transmission status report(s) have been received (block 406), scheduling uplink data transmissions for serviceable report(s) (block 408), receiving uplink data via scheduled uplink data transmissions (block 410), and determining if there is an additional reporting window scheduled (block 412). Although the illustrated embodiments include a two-session multi-poll process, embodiments may include three or more sessions.

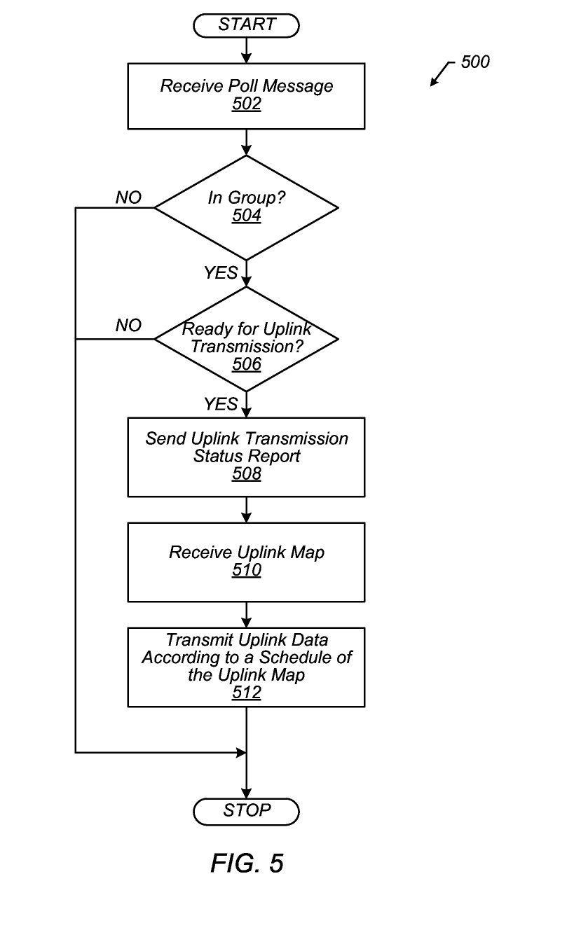

FIG. 5 is a flow diagram illustrating a method 500 for performing uplink (burst) transmissions in accordance with one or more embodiments of the present technique. Method 500 may generally include receiving a poll message (block 502), determining whether the receiving device is in the group to which the poll message is directed/addressed (block 504), determining whether the device is ready for uplink data transmission (e.g., it is ready for an uplink transfer and/or has uplink data to transfer) (block 506) and, if the receiving device is in the group to which the poll message is directed/addressed and is ready for uplink data transmission (e.g., it is ready for an uplink transfer and/or has uplink data to transfer), sending an uplink transmission status report (block 508), receiving an uplink data map (block 510), and transmitting uplink data according to a schedule of the uplink data map (block 512).

In some embodiments, receiving a poll message (block 502) includes the STA 104 receiving a poll message 202 broadcast by the AP 102. For example, referring to embodiments of FIGS. 2A and 2B, receiving a poll message may include STA1 104a, STA2 104b, STA3 104c and STA4 104d receiving the poll message 202 broadcast by the AP 102 (e.g., via the reserved channel).

In some embodiments, determining whether the receiving device is in the group to which the poll message is addressed (block 504) includes the STA 104 determining whether it is in the group to which the poll message is addressed. For example, referring to embodiments of FIGS. 2A and 2B, receiving a poll message may include each of STA1 104a, STA2 104b, STA3 104c and STA4 104d determining whether it is part of the group “1234” specified by the group identifier 204 of the poll message 202. In the illustrated embodiment, for example, STA1 104a, STA2 104b and STA3 104c may determine that they are part of the group to which the poll message is addressed, but STA4 104d may determine that it is not part of the group to which the poll message 202 is addressed. As a result, STA4 104d may remain quiet.

In some embodiments, determining whether the device is ready for uplink data transmission (e.g., it is ready for an uplink transfer and/or has uplink data to transfer) (block 506) includes the STA 104 determining whether it has sufficient uplink data to warrant reserving an uplink transmission to the AP 102. In some embodiments, it may be determined that the STA 104 has sufficient uplink data to warrant reserving an uplink transmission to the AP 102 if it has any uplink data 106 in its buffer 108 and/or is ready for an uplink transmission. In some embodiments, it may be determined that the STA 104 has sufficient uplink data 106 to warrant reserving an uplink transmission to the AP 102 if it has at least a threshold amount of uplink data 106 in its buffer 108 and/or is ready for an uplink transmission. For example, the poll message 202 may indicate a threshold amount of data required to reserve an uplink block (e.g., enough data to fill at least one-third of an uplink block's capacity), and it may be determined that the STA 104 has sufficient uplink data 106 to warrant reserving an uplink transmission to the AP 102 if it has at least the threshold amount of uplink data 106 in its buffer 108 and/or is ready for an uplink transmission. For example, referring to the embodiments of FIGS. 2A and 2B, each of STA1 104a and STA3 104c may determine that it has sufficient uplink data 106 to warrant reserving an uplink transmission to the AP 102. STA2 104b may determine that it does not have sufficient uplink data 106 to warrant reserving an uplink transmission to the AP 102. As a result, STA2 104b may remain quiet.

In some embodiments, in response to determining that it is in the group to which the poll message is addressed and has sufficient uplink data to transfer, a device may send an uplink transmission status report (block 508). For example, referring to the embodiments of FIGS. 2A and 2B, in response to STA1 104a and STA3 104c determining that they are in the group to which the poll message 202 was addressed and they each have sufficient uplink data 106 to warrant reserving an uplink transmission to the AP 102, each of STA1 104a and STA3 104c may send a report 210 to the AP 102 during the corresponding reporting window 206 (e.g., via the reserved channel).

In some embodiments, receiving an uplink data map (block 510) includes a STA 104 receiving the uplink map 216 transmitted by the AP 102. For example, referring to embodiments of FIGS. 2A and 2B, receiving an uplink data map may include at least STA1 104a and STA3 104c receiving the uplink data map 216 broadcast by the AP 102 (e.g., on the reserved channel).

In some embodiments, transmitting uplink data according to a schedule of the uplink data map (block 512) includes a STA 104 transmitting its uplink data 106 according to a schedule outlined in the uplink data map 210 received from the AP 102. For example, referring to an embodiment of FIG. 2A, transmitting uplink data 106 according to a schedule of the uplink data map 216 may include STA1 104a transmitting its uplink data 106 to the AP 102 (e.g., via the reserved channel) during the uplink block 212. Referring to an embodiment of FIG. 2B, transmitting uplink data 106 according to a schedule of the uplink data map 216 may include STA1 104a transmitting its uplink data 106 to the AP 102 (e.g., via the reserved channel) during the uplink block 212a and STA3 104c transmitting its uplink data 106 to the AP 102 (e.g., via the reserved channel) during the uplink block 212b.

It will be appreciated that the methods 400 and 500 are exemplary embodiments of methods that may be employed in accordance with the techniques described herein. The methods 400 and 500 may be modified to facilitate variations of their implementations and uses. The order of the methods 400 and 500 and the operations provided therein may be changed, and various elements may be added, reordered, combined, omitted, modified, etc. The methods 400 and 500 may be implemented in software, hardware, or a combination thereof. Some or all of the methods 400 and 500 may be implemented by one or more of the modules/applications described herein. In some embodiments, some or all of methods 400 and 500 may be implemented by one or more of the modules/applications described herein and/or may be executed on one or more devices. For example, the method 400 may be employed by an AP 102, and the method 500 may be employed by a STA 104.

FIG. 6 is a block diagram illustrating an exemplary communication device 600 in accordance with one or more exemplary embodiments. In some embodiments, the AP 102 and/or a STA 104 may include and/or employ a device that is the same or similar to the communication device 600. The communication device 600 may be, for example, a handheld device, a mobile device, a cellular telephone, a smartphone, a tablet, a netbook, a wireless terminal, a laptop computer, a femtocell, a High Data Rate (HDR) subscriber station, an access point, an access terminal, or other personal communication system (PCS) device.

The communication device 600 may include physical layer circuitry 602 having a transceiver 610 for transmitting and receiving signals to and from other communication stations using one or more antennas 601. The antennas 601 may include one or more directional or omnidirectional antennas including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

The communication device 600 may include one or more processors (e.g., processing circuitry) 606 and memory 608 arranged to perform the operations described herein. In some embodiments, the physical layer circuitry 602 and the processing circuitry 606 may be configured to perform the operations detailed herein.

In accordance with some embodiments, the MAC circuitry 604 may be arranged to contend for a wireless medium and configure frames or packets for communicating over the wireless medium, and the physical layer circuitry 602 may be arranged to transmit and receive signals. The physical layer circuitry 602 may include circuitry for modulation/demodulation, upconversion/downconversion, filtering, amplification, etc. In some embodiments, the physical layer circuitry 602 may include any suitable circuitry that is capable of performing the processing tasks described herein. For example, the physical layer circuitry 602 may include one or more application-specific integrated circuits (ASICs) and/or the like. In some embodiments, two or more antennas 601 may be coupled to the physical layer circuitry 602 arranged for sending and receiving signals. The memory 608 may store information for configuring the processing circuitry 606 to perform operations for configuring and transmitting message frames and/or performing the various operations described herein.

The memory 608 may include any type of memory, including a non-transitory memory, for storing information in a form readable by a machine (e.g., a computer). For example, the memory 608 may include a computer-readable storage device such as read-only memory (ROM), random-access memory (RAM), magnetic disk storage media, optical storage media, flash-memory devices, and other storage devices and media. The memory 608 may include a non-transitory computer-readable storage medium having program instructions 609 stored thereon that are executable by a computer processor (e.g., the processing circuitry 606) to cause the functional operations (e.g., the methods/routines/processes) described herein, including those described with regard to the AP 102 and the STAs 104. The program instructions 609 may include one or more software modules 609a (e.g., including program instructions) that are executable by the processor to provide some or all of the functionality described herein with regard to the AP 102 and the STAs 104. The program instructions 609 may include a module 609a for performing some or all of the operational aspects of the method 400 (described with regard to FIG. 4) and/or the method 500 (described with regard to FIG. 5). Processing circuitry 606 may include a central processing unit (CPU) that carries out program instructions (e.g., program instructions of the module 609a) to perform arithmetical, logical, and input/output operations described herein.

In some embodiments, the communication device 600 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), or another device that may receive and/or transmit information wirelessly.

In some embodiments, the communication device 600 may include one or more of a keyboard, a display, a non-volatile memory port, multiple antennas, a graphics processor, an application processor, speakers, and other mobile device elements. The display may be an LCD screen including a touch screen.

Although the communication device 600 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application-specific integrated circuits (ASICs), radio-frequency integrated circuits (RFICs), and combinations of various hardware and logic circuitry for performing at least the functions described herein. In some embodiments, the functional elements of the communication device 600 may refer to one or more processes operating on one or more processing elements.

FIG. 7 is a block diagram illustrating an exemplary computer device 700 in accordance with one or more exemplary embodiments. In some embodiments, the AP 102, the STA 104 and/or the communication device 600 may include and/or employ a device that is the same or similar to the computer device 700. Some or all of the techniques (e.g., methodologies) discussed herein may be performed on a machine similar to that of the computer device 700. The computer device 700 may operate as a standalone device or may be connected (e.g., networked) to other machines. In a networked deployment, the computer device 700 may operate in the capacity of a server machine, a client machine, or both in server-client network environments. In an example, the computer device 700 may act as a peer machine in a peer-to-peer (P2P) (or other distributed) network environment. The computer device 700 may be a personal computer (PC), a tablet PC, a set-top box (STB), a personal digital assistant (PDA), a mobile telephone, a web appliance, a network router, a switch or a bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer-readable medium containing instructions, where the instructions configure the execution units to carry out a specific operation when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The computer device (e.g., machine) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The computer device 700 may further include a power management device 732, a graphics display device 710, an alphanumeric input device 712 (e.g., a keyboard), and a user interface (UI) navigation device 714 (e.g., a mouse). In an example, the graphics display device 710, the alphanumeric input device 712, and the UI navigation device 714 may be a touch screen display. The computer device 700 may additionally include a storage device (i.e., drive unit) 716, a signal generation device 718 (e.g., a speaker), a network interface device/transceiver 720 coupled to antenna(s) 730, and one or more sensors 728, such as a global positioning system (GPS) sensor, a compass, an accelerometer, or other sensor. The computer device 700 may include an output controller 734, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.). In some embodiments, the hardware processor 702 includes any suitable circuitry that is capable of performing the processing task described herein. For example, the hardware processor 702 may include one or more application-specific integrated circuits (ASICs) and/or the like.

The storage device 716 may include a non-transitory machine-readable medium 722 on which is stored one or more sets of data structures or instructions 724 (e.g., software) embodying or utilized by any one or more of the techniques or functions described herein. The instructions 724 may also reside, completely or at least partially, within the main memory 704, within the static memory 706, or within the hardware processor 702 during execution thereof by the computer device 700. In an example, one or any combination of the hardware processor 702, the main memory 704, the static memory 706, or the storage device 716 may constitute machine-readable media. While the machine-readable medium 722 is illustrated as a single medium, the term “machine readable medium” may include a single medium or multiple media (e.g., a centralized or distributed database, and/or associated caches and servers) configured to store the one or more instructions 724. The term “machine-readable medium” may include any medium that is capable of storing, encoding, or carrying instructions for execution by the computer device 700 and that cause the computer device 700 to perform any one or more of the techniques of the present disclosure, or that is capable of storing, encoding, or carrying data structures used by or associated with such instructions. Non-limiting machine-readable medium examples may include solid-state memories, and optical and magnetic media. In an example, a massed machine-readable medium includes a machine-readable medium with a plurality of particles having resting mass. Specific examples of massed machine-readable media may include: non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device/transceiver 720 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 720 may include one or more physical jacks (e.g., Ethernet, coaxial, or phone jacks) or one or more antennas to connect to the communications network 726. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the computer device 700, and includes digital or analog communications signals or other intangible media to facilitate communication of such software.

Accordingly, described herein are systems and methods in accordance with the following numbered embodiments:

1. A wireless network access point, comprising:

one or more processors; and

one or more memory devices storing program instructions that are executable by the one or more processors to cause:
polling a group of wireless network stations for an uplink transmission status;
receiving, from one or more wireless network stations of the group of wireless network stations, an uplink transmission status report indicating that the wireless network station is ready for uplink data transmission;
scheduling, in response to receiving the one or more uplink transmission status reports, one or more uplink data transmissions from the one or more wireless network stations; and
receiving, from the one or more wireless network stations in accordance with the scheduling, one or more uplink data transmissions comprising uplink data.
   2. The wireless network access point of 1, wherein polling a group of wireless network stations for an uplink transmission status comprises:

broadcasting or multicasting a poll message comprising a group identifier that corresponds to the group of wireless network stations.

3. The wireless network access point of 2, wherein wireless network stations that are not associated with the group identifier are configured to not provide an uplink transmission status report in response to receiving the poll message.
4. The wireless network access point of 1, wherein wireless network stations that do not have sufficient uplink data for an uplink data transmission are configured to not provide an uplink transmission status report in response to receiving the poll message.
5. The wireless network access point of 1, wherein an uplink transmission status report comprises:

a single bit identifier indicating that the wireless network station is ready for uplink data transmission.

6. The wireless network access point of 1, wherein an uplink transmission status report comprises:
a data size specifying an amount of data to be transferred via an uplink data transmission.
   7. The wireless network access point of 1, further comprising:
   reserving a wireless network channel,

wherein polling a group of wireless network stations for an uplink transmission status comprises polling, via the wireless network channel, a group of wireless network stations for an uplink transmission status;

wherein receiving an uplink transmission status report comprises receiving, from one or more wireless network stations of the group of wireless network stations and via the wireless network channel, an uplink transmission status report;

wherein the one or more uplink data transmissions are scheduled to occur on the wireless network channel; and

wherein receiving one or more uplink data transmissions comprising uplink data comprises receiving, from the one or more wireless network stations in accordance with the scheduling and via the wireless network channel, one or more uplink data transmissions comprising uplink data.

8. The wireless network access point of 1, further comprising reserving a wireless network channel for a first time period,

wherein scheduling one or more uplink data transmissions from the one or more wireless network stations comprises:

scheduling a first uplink data transmission from a first wireless network station to occur on the wireless network channel during a first block of time within the first time period.

9. The wireless network access point of 8, wherein scheduling one or more uplink data transmissions from the one or more wireless network stations comprises:

scheduling a second uplink data transmission from a second wireless network station to occur on the wireless network channel during a second block of time within the first time period.

10. The wireless network access point of 1, wherein scheduling one or more uplink data transmissions from the one or more wireless network stations comprises:

scheduling uplink blocks for one or more uplink data transmissions from the one or more wireless network stations; and

transmitting, to the one or more wireless network stations and prior to the start of the uplink blocks, an uplink map indicative of the uplink blocks scheduled.

11. The wireless network access point of 10, wherein the uplink map specifies for each of one or more wireless network stations scheduled to transfer uplink data, an uplink block allotted for the wireless network station to transmit uplink data to the wireless network access point.
12. The wireless network access point of 1, wherein the uplink data received from at least one of the wireless network stations comprises:

a supplemental report indicating that the wireless network station has additional uplink data to be transferred via an uplink data transmission, and

further comprising:

scheduling, based at least in part on the supplemental report, one or more additional uplink data transmissions from the at least one of the wireless network stations.

13. The wireless network access point of 1, further comprising:

reserving a wireless network channel for a first time period for polling the group of wireless network stations for an uplink transmission status, wherein the first time period is sufficient to provide for polling the group of wireless network stations for an uplink transmission status and receiving uplink transmission status reports from one or more wireless network stations of the group of wireless network stations; and
in response to receiving, from one or more wireless network stations of the group of wireless network stations, an uplink transmission status report indicating that the wireless network station is ready for uplink data transmission, reserving the wireless network channel for a second time period, wherein the second time period is sufficient to provide for scheduling the one or more uplink data transmissions from the one or more wireless network stations and receiving one or more uplink data transmissions comprising uplink data from the one or more wireless network stations in accordance with the scheduling.
   14. The wireless network access point of 1, further comprising reserving a wireless network channel for a time period,

wherein polling a group of wireless network stations for an uplink transmission status comprises:
providing, within the time period for which the network channel is reserved, a first reporting time period for providing uplink transmission status reports; and
providing, within the time period for which the network channel is reserved, a second reporting time period for providing uplink transmission status reports,

wherein receiving, from one or more wireless network stations of the group of wireless network stations, an uplink transmission status report indicating that the wireless network station is ready for uplink data transmission comprises:
receiving a first uplink transmission status report from a first wireless network station during the first reporting period; and
receiving a second uplink transmission status report from a second wireless network station during the second reporting period, and

wherein scheduling one or more uplink data transmissions from the one or more wireless network stations comprises:
scheduling a first uplink data transmission from the first wireless network station during a first block of time that occurs between an end of the first reporting time period and a beginning of the second reporting time period; and
scheduling a second uplink data transmission from the second wireless network station during a second block of time that occurs between an end of the second reporting time period and the end of the time period for which the network channel is reserved.
   15. The wireless network access point of 1, wherein the access point is a wireless local area network (WLAN) access point.
   16. The wireless network access point of 1, wherein an uplink transmission status report indicating that the wireless network station is ready for uplink data transmission comprises an uplink transmission status report indicating that the wireless network station is ready for an uplink transfer and/or it has uplink data to transfer.
   17. The wireless network access point of 1, wherein the access point comprises a wireless transceiver, wherein the respective wireless network stations comprise a wireless transceiver, and wherein the access point communicates wirelessly with the respective wireless network stations via the respective transceivers.
   18. The wireless network access point of 1, wherein the access point comprises a wireless antenna, wherein the respective wireless network stations comprise a wireless antenna, and wherein the access point communicates wirelessly with the respective wireless network stations via the respective antennas.
   19. A non-transitory computer-readable storage medium comprising program instructions stored thereon that are executable by one or more processors to cause the following:
polling, by a wireless network access point, a group of wireless network stations for an uplink transmission status;
receiving, from one or more wireless network stations of the group of wireless network stations, an uplink transmission status report indicating that the wireless network station is ready for uplink data transmission;
scheduling, in response to receiving the one or more uplink transmission status reports, one or more uplink data transmissions from the one or more wireless network stations; and
receiving, from the one or more wireless network stations in accordance with the scheduling, one or more uplink data transmissions comprising uplink data.
   20. The medium of 19, wherein an uplink transmission status report indicating that the wireless network station is ready for uplink data transmission comprises an uplink transmission status report indicating that the wireless network station is ready for an uplink transfer and/or it has uplink data to transfer.
   21. A method, comprising:
polling, by a wireless network access point, a group of wireless network stations for an uplink transmission status;
receiving, from one or more wireless network stations of the group of wireless network stations, an uplink transmission status report indicating that the wireless network station is ready for uplink data transmission;
scheduling, in response to receiving the one or more uplink transmission status reports, one or more uplink data transmissions from the one or more wireless network stations; and
receiving, from the one or more wireless network stations in accordance with the scheduling, one or more uplink data transmissions comprising uplink data.
   22. The method of 21, wherein an uplink transmission status report indicating that the wireless network station is ready for uplink data transmission comprises an uplink transmission status report indicating that the wireless network station is ready for an uplink transfer and/or it has uplink data to transfer.
   23. A wireless network station, comprising:

one or more processors; and

one or more memory devices storing program instructions that are executable by the one or more processors to cause:
receiving a poll message from a wireless network access point;
determining whether the wireless network station is ready for uplink data transmission;
sending, in response to determining that the wireless network station is ready for uplink data transmission and to the wireless network access point, an uplink transmission status report;
receiving, from the wireless network access point, an uplink data map based at least in part on the uplink transmission status report; and
transmitting, to the wireless network access point and in accordance with scheduling of the uplink data map, uplink data.
   24. The wireless network station of 23, further comprising:

determining whether the poll message is directed to the wireless network station,

wherein sending an uplink transmission status report comprises sending, in response to determining that the poll message is directed to the wireless network station and that the wireless network station is ready for uplink data transmission and to the wireless network access point, an uplink transmission status report.

25. The wireless network station of 23, wherein the wireless network station is a wireless local area network (WLAN) station.

Further described herein are systems and methods in accordance with the following numbered embodiments:

1. A communication station arranged for Clear Channel Assessment (CCA) channel status reporting, the communication station comprising physical layer circuitry, memory and processing elements to:
receive, from an access point (AP), a CCA channel status report request on an allocated channel resource; and
transmit, to the AP using Frequency Division Multiple Access (FDMA), a CCA channel status or bandwidth request response.
2. The communication station of 1 further arranged to transmit the CCA channel status response over a unique subcarrier.
3. The communication station of 1 further arranged to transmit a preamble with a short period for reduced time estimation of a dynamic range of a received signal by the AP.
4. A non-transitory computer-readable storage device including instructions stored thereon, which when executed by one or more processor(s) of a communication station, cause the communication station to perform operations to:

receive, from an access point (AP) a CCA channel status report request on an allocated channel resource; and

transmit, to the AP using Frequency Division Multiple Access (FDMA), a CCA channel status or bandwidth request response.

5. The non-transitory computer-readable storage device of 4 further including instructions thereon to transmit the CCA channel status response over a unique subcarrier.
6. The non-transitory computer-readable storage device of 4 further including instructions thereon to transmit a preamble with a short period for reduced time estimation of a dynamic range of a received signal by the AP.
7. An access point (AP) arranged for Clear Channel Assessment (CCA) channel status report polling, the AP comprising physical layer circuitry, memory and processing elements to:

allocate a channel resource for a communication station (STA) to report CCA channel status;

transmit, to a communication station (STA), a CCA channel status report request; and

receive, from the STA using the allocated channel resource, a CCA channel status or bandwidth request response.

8. The AP of 7 further arranged to receive the CCA channel status response over a unique subcarrier.
9. The AP of 7 further arranged to receive a preamble with a short period for reduced time estimation of a dynamic range of a received signal by the AP.
10. The AP of 7 further arranged to determine the CCA report status of the STA by measuring the received power level on a subcarrier of an OFDM symbol.

As used throughout this application, the word “may” is used in a permissive sense (i.e., meaning having the potential to), rather than the mandatory sense (i.e., meaning must). The words “include,” “including,” and “includes” mean including, but not limited to. As used throughout this application, the singular forms “a” “an,” and “the” include plural referents unless the content clearly indicates otherwise. Thus, for example, reference to “an element” may include a combination of two or more elements. As used throughout this application, the phrase “based on” does not limit the associated operation to being solely based on a particular item. Thus, for example, processing “based on” data A may include processing based at least in part on data A and based at least in part on data B unless the content clearly indicates otherwise. Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

What is claimed is:

1. A wireless network access point, comprising:
one or more processors; and
one or more memory devices storing program instructions that are executable by the one or more processors to cause:
polling a group of wireless network stations for an uplink transmission status;
receiving, from one or more wireless network stations of the group of wireless network stations, an uplink transmission status report indicating that the wireless network station is ready for uplink data transmission;
scheduling, in response to receiving the one or more uplink transmission status reports, one or more uplink data transmissions from the one or more wireless network stations; and
receiving, from the one or more wireless network stations in accordance with the scheduling, one or more uplink data transmissions comprising uplink data.

2. The wireless network access point of claim 1, wherein polling the group of wireless network stations for an uplink transmission status comprises:
broadcasting or multicasting a poll message comprising a group identifier that corresponds to the group of wireless network stations.

3. The wireless network access point of claim 2, wherein wireless network stations that are not associated with the group identifier are configured to not provide an uplink transmission status report in response to receiving the poll message.

4. The wireless network access point of claim 1, wherein wireless network stations that do not have sufficient uplink data for an uplink data transmission are configured to not provide an uplink transmission status report in response to receiving the poll message.

5. The wireless network access point of claim 1, wherein an uplink transmission status report comprises:
a single bit identifier indicating that the wireless network station is ready for uplink data transmission.

6. The wireless network access point of claim 1, wherein an uplink transmission status report comprises:
a data size specifying an amount of data to be transferred via an uplink data transmission.

7. The wireless network access point of claim 1, further comprising:
reserving a wireless network channel,
wherein polling a group of wireless network stations for an uplink transmission status comprises polling, via the wireless network channel, a group of wireless network stations for an uplink transmission status;
wherein receiving an uplink transmission status report comprises receiving, from one or more wireless network stations of the group of wireless network stations and via the wireless network channel, an uplink transmission status report;
wherein the one or more uplink data transmissions are scheduled to occur on the wireless network channel; and
wherein receiving one or more uplink data transmissions comprising uplink data comprises receiving, from the one or more wireless network stations in accordance with the scheduling and via the wireless network channel, one or more uplink data transmissions comprising uplink data.

8. The wireless network access point of claim 1, further comprising reserving a wireless network channel for a first time period,
wherein scheduling one or more uplink data transmissions from the one or more wireless network stations comprises:
scheduling a first uplink data transmission from a first wireless network station to occur on the wireless network channel during a first block of time within the first time period.

9. The wireless network access point of claim 8, wherein scheduling one or more uplink data transmissions from the one or more wireless network stations comprises:
scheduling a second uplink data transmission from a second wireless network station to occur on the wireless network channel during a second block of time within the first time period.

10. The wireless network access point of claim 1, wherein scheduling one or more uplink data transmissions from the one or more wireless network stations comprises:
scheduling uplink blocks for one or more uplink data transmissions from the one or more wireless network stations; and
transmitting, to the one or more wireless network stations and prior to the start of the uplink blocks, an uplink map indicative of the uplink blocks scheduled.

11. The wireless network access point of claim 10, wherein the uplink map specifies for each of one or more wireless network stations scheduled to transfer uplink data, an uplink block allotted for the wireless network station to transmit uplink data to the wireless network access point.

12. The wireless network access point of claim 1, wherein the uplink data received from at least one of the wireless network stations comprises:
a supplemental report indicating that the wireless network station has additional uplink data to be transferred via an uplink data transmission, and
further comprising:
scheduling, based at least in part on the supplemental report, one or more additional uplink data transmissions from the at least one of the wireless network stations.

13. The wireless network access point of claim 1, further comprising:
reserving a wireless network channel for a first time period for polling the group of wireless network stations for an uplink transmission status, wherein the first time period is sufficient to provide for polling the group of wireless network stations for an uplink transmission status and receiving uplink transmission status reports from one or more wireless network stations of the group of wireless network stations; and
in response to receiving, from one or more wireless network stations of the group of wireless network stations, an uplink transmission status report indicating that the wireless network station is ready for uplink data transmission, reserving the wireless network channel for a second time period, wherein the second time period is sufficient to provide for scheduling the one or more uplink data transmissions from the one or more wireless network stations and receiving one or more uplink data transmissions comprising uplink data from the one or more wireless network stations in accordance with the scheduling.

14. The wireless network access point of claim 1, further comprising reserving a wireless network channel for a time period,
wherein polling a group of wireless network stations for an uplink transmission status comprises:
providing, within the time period for which the network channel is reserved, a first reporting time period for providing uplink transmission status reports; and
providing, within the time period for which the network channel is reserved, a second reporting time period for providing uplink transmission status reports,
wherein receiving, from one or more wireless network stations of the group of wireless network stations, an uplink transmission status report indicating that the wireless network station is ready for uplink data transmission comprises:
receiving a first uplink transmission status report from a first wireless network station during the first reporting period; and
receiving a second uplink transmission status report from a second wireless network station during the second reporting period, and
wherein scheduling one or more uplink data transmissions from the one or more wireless network stations comprises:
scheduling a first uplink data transmission from the first wireless network station during a first block of time that occurs between an end of the first reporting time period and a beginning of the second reporting time period; and
scheduling a second uplink data transmission from the second wireless network station during a second block of time that occurs between an end of the second reporting time period and the end of the time period for which the network channel is reserved.

15. The wireless network access point of claim 1, wherein the access point is a wireless local area network (WLAN) access point.

16. The wireless network access point of claim 1, wherein an uplink transmission status report indicating that the wireless network station is ready for uplink data transmission comprises an uplink transmission status report indicating that the wireless network station is ready for an uplink transfer and/or it has uplink data to transfer.

17. The wireless network access point of claim 1, wherein the access point comprises a wireless transceiver, wherein the respective wireless network stations comprise a wireless transceiver, and wherein the access point communicates wirelessly with the respective wireless network stations via the respective transceivers.

18. The wireless network access point of claim 1, wherein the access point comprises a wireless antenna, wherein the respective wireless network stations comprise a wireless antenna, and wherein the access point communicates wirelessly with the respective wireless network stations via the respective antennas.

19. A non-transitory computer-readable storage medium comprising program instructions stored thereon that are executable by one or more processors to cause the following:
polling, by a wireless network access point, a group of wireless network stations for an uplink transmission status;
receiving, from one or more wireless network stations of the group of wireless network stations, an uplink transmission status report indicating that the wireless network station is ready for uplink data transmission;
scheduling, in response to receiving the one or more uplink transmission status reports, one or more uplink data transmissions from the one or more wireless network stations; and
receiving, from the one or more wireless network stations in accordance with the scheduling, one or more uplink data transmissions comprising uplink data.

20. The medium of claim 19, wherein an uplink transmission status report indicating that the wireless network station is ready for uplink data transmission comprises an uplink transmission status report indicating that the wireless network station is ready for an uplink transfer and/or it has uplink data to transfer.

21. A method, comprising:
polling, by a wireless network access point, a group of wireless network stations for an uplink transmission status;
receiving, from one or more wireless network stations of the group of wireless network stations, an uplink transmission status report indicating that the wireless network station is ready for uplink data transmission;
scheduling, in response to receiving the one or more uplink transmission status reports, one or more uplink data transmissions from the one or more wireless network stations; and
receiving, from the one or more wireless network stations in accordance with the scheduling, one or more uplink data transmissions comprising uplink data.

22. The method of claim 21, wherein an uplink transmission status report indicating that the wireless network station is ready for uplink data transmission comprises an uplink transmission status report indicating that the wireless network station is ready for an uplink transfer and/or it has uplink data to transfer.

23. A wireless network station, comprising:
one or more processors; and
one or more memory devices storing program instructions that are executable by the one or more processors to cause:
receiving a poll message from a wireless network access point;
determining whether the wireless network station is ready for uplink data transmission;
sending, in response to determining that the wireless network station is ready for uplink data transmission and to the wireless network access point, an uplink transmission status report;
receiving, from the wireless network access point, an uplink data map based at least in part on the uplink transmission status report; and
transmitting, to the wireless network access point and in accordance with scheduling of the uplink data map, uplink data.

24. The wireless network station of claim 23, further comprising:
determining whether the poll message is directed to the wireless network station,
wherein sending an uplink transmission status report comprises sending, in response to determining that the poll message is directed to the wireless network station and that the wireless network station is ready for uplink data transmission and to the wireless network access point, an uplink transmission status report.

25. The wireless network station of claim 23, wherein the wireless network station is a wireless local area network (WLAN) station.
